(19) United States
(12) Patent Application Publication
(10) Pub. No.: US 2013/0266129 A1
(43) Pub. Date: Oct. 10, 2013

(54) METHOD AND SYSTEM FOR RECALLING A VOICE MAIL

(71) Applicants: Basavaraj Jayawant Pattan, Bangalore (IN); Venkateswar Jeedigunta, Bangalore (IN)

(72) Inventors: Basavaraj Jayawant Pattan, Bangalore (IN); Venkateswar Jeedigunta, Bangalore (IN)

(73) Assignee: Samsung Electronics Co., Ltd., Gyeonggi-do (KR)

(21) Appl. No.: 13/994,033

(22) PCT Filed: Dec. 13, 2011
(86) PCT No.: PCT/KR2011/009580

§ 371 Date: Jun. 13, 2013

(30) Foreign Application Priority Data
Dec. 13, 2010 (IN) 3815/CHE/2010

(51) Int. Cl. H04M 3/533

(52) U.S. Cl. CPC H04M 3/53358
USPC 379/88.11

(57) ABSTRACT

A method and a system are provided for recalling a voice mail stored in a voice mail server. The method includes receiving, by the voice mail server, a request to recall the voice mail from a sender client device; performing a recall action on the voice mail, based on the received request; and notifying at least one of the sender client device and the recipient client device of a status of the recall action.

### PRIORITY

This application is a National Phase Entry of PCT International Application No. PCT/KR2011/009580, which was filed on Dec. 13, 2011, and claims priority to Indian Patent Application No. 3815/CHE/2010, which was filed in the Indian Industrial Property Office on Dec. 13, 2010, the content of each of which are incorporated herein by reference.

### BACKGROUND

1. Field of the Invention

The present invention relates generally to a voice mail system, and more particularly, to a method and system of recalling a voice mail stored in a voice mail server.

2. Description of the Related Art

The expanding capabilities of mobile communications devices such as cellular telephones, mobile communication devices, Personal Digital Assistants (PDAs), laptops, etc., has led to the improvement and enhancement of more traditional technologies. For example, voicemail has traditionally been an audio-only feature that requires a telephone connection to a voicemail server. An intended recipient would receive a message waiting notification that a voicemail is available, and the recipient would then have to dial into the voicemail server to listen to the message.

However, today, visual voicemail is available on many mobile communications devices, which presents a visual interface to a user's voicemail box and allows the user to manipulate voicemail in various ways that were previously not possible. For example, a user may delete or save voicemail through the visual interface without having to place a telephone call to a voicemail server. A user may also be able to see who the voicemail is from, when it was sent or received, or other characteristic of the voicemail, without actually placing a telephone call to a voicemail server. In some implementations, voicemail can be converted to text using speech recognition technology and then read through the visual voicemail interface or transmitted, for example, as an email or text message.

Currently, when a sender device leaves a voice mail in a voice mail server, the voice mail server sends a notification to an intended recipient device indicating that a new voice mail is stored therein. Thereafter, the intended recipient device can retrieve the voice mail from the voice mail server. However, after leaving the voice mail, if the sender device wishes to recall the voice mail, a visual voice mail service does not provide a function that allows the sender device to recall the voicemail stored in the voice mail server.

### SUMMARY

The present invention is designed to address at least the problems and/or disadvantages described above and to provide at least the advantages described below.

An aspect of the present invention is to provide a system and method for recalling a voice mail previously stored in a voice mail server using a visual voice mail service.

In accordance with an aspect of the present invention, a method is provided for recalling a voice mail for a recipient client device that is stored in a voice mail server. The method includes receiving, by the voice mail server, a request to recall the voice mail from a sender client device; performing a recall action on the voice mail, based on the received request; and notifying at least one of the sender client device and the recipient client device of a status of the recall action.

In accordance with another aspect of the present invention, an apparatus is provided for recalling a voice mail for a recipient client device that is stored in a voice mail server. The apparatus includes a processor; and a memory coupled to the processor. The memory includes a voice mail recall module, which when executed by the processor is configured to receive a request to recall the voice mail from a sender client device, perform a recall action on the voice mail, based on the received request, and notify at least one of the sender client device and the recipient client device of a status of the recall action.

In accordance with another aspect of the present invention, a non-transitory computer-readable storage medium having instructions stored therein is provided, which when executed by a processor, cause the processor to perform a method of recalling a voice mail for a recipient client device that is stored in a voice mail server. The method includes receiving a request to recall the voice mail from a sender client device; performing a recall action on the voice mail, based on the received request; and notifying at least one of the sender client device and the recipient client device of a status of the recall action.

In accordance with another aspect of the present invention, a system is provided including a sender client device; a recipient client device; a voice mail server; and an Internet Protocol (IP) network communicatively coupling the sender client device, the recipient client device, and the voice mail server. The sender client device is configured to send a request to recall a voice mail for the recipient client device over the IP network, and the voice mail server is configured to perform a recall action on the voice mail, based on the request, and to notify at least one of the sender client device and the recipient client device of a status of the recall action.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a voice mail system configured to recall voice mails from visual voice mail devices, according to an embodiment of the present invention;

FIG. 2 is a signal flow diagram illustrating a method of recalling a voice mail stored in a voice mail server, according to an embodiment of the present invention;

FIG. 3 is a signal flow diagram illustrating a method of recalling a voice mail stored voice mail server, according to an embodiment of the present invention;

FIG. 4 is a block diagram illustrating a voice mail server according to an embodiment of the present invention; and

FIG. 5 is a block diagram illustrating a visual voice mail device according to an embodiment of the present invention.

### DETAILED DESCRIPTION OF EMBODIMENTS OF THE INVENTION

Various embodiments of the present invention will now be described in detail with reference to the accompanying drawings. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

Herein, the terms “visual voice mail devices” and “client devices” are used interchangeably throughout the document.

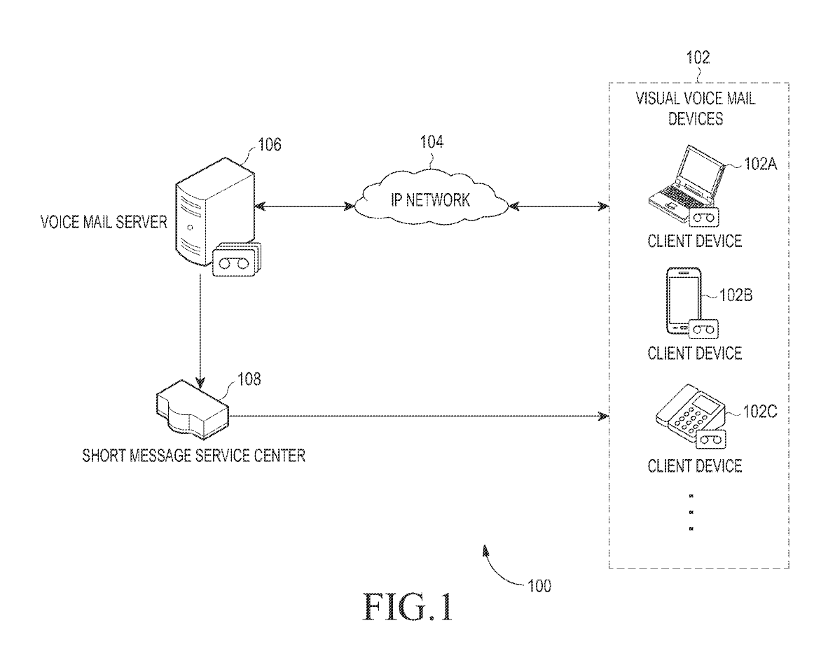

FIG. 1 is a block diagram illustrating a voice mail system configured to recall voice mails from visual voice mail devices, according to an embodiment of the present invention.

Referring to FIG. 1, the voice mail system 100 includes visual voice mail devices 102A-C, an Internet Protocol (IP) network 104, a voice mail server 106, and a notification entity 108 (e.g., a Short Message Service Center (SMSC)). The voice mail system 100 may also include legacy devices (not shown) that send and receive voice mails through a Public Switched Telephone Network (PSTN).

The visual voice mail devices 102A-C may include devices associated with different users, such as digital phone, laptop, desktop, smart phone, tablet, personal digital assistant, etc., providing random access voicemail features via a visual interface. For example, the voice mail server 106 may be a remote server connected to the visual voice mail devices 102A-C via the IP network 104 for delivering voice mail services.

The voice mail server 106 may be associated with a service provider network. For example, when the visual voice mail devices 102A-C are associated with different service provider networks, the voice mail system 100 may include multiple voice mail servers associated with different service provider networks for delivering voice mail services. However for the purpose of illustration, in FIG. 1, the voice mail system 100 includes a single voice mail server 106 delivering voice mail services to the visual voice mail devices 102. The SMSC 108 is a network element connected to the voice mail server 106 for delivering voice mail notifications to the visual voice mail devices 102A-C via an SMS message.

When the client device 102A sends a voice mail for the client device 102B over the IP network 104 using a Simple Mail Transfer Protocol (SMTP), the client device 102A also requests a voice mail identifier (e.g., Internet Message Access Protocol (IMAP) Unified Resource Locator (URL) or IMAP identifier) for the voice mail in the SMTP packet. For example, the header of the SMTP packet includes delivery notification required field, and an RHDRS (Return Headers) field. The RHDRS field indicates whether the voice mail identifier is to be returned in a voice mail submission notification.

The voice mail server 106 stores the received voice mail in a memory and assigns a voice mail identifier to the voice mail. Thereafter, the voice mail server 106 sends a successful voice mail submission notification to the client device 102A. The voice mail server 106 includes the voice mail identifier in the voice mail submission notification, based on the value of RHDRS in the received packet header. For example, the voice mail submission notification includes a return delivery (r-delivery) status field in a report type in a content type header to indicate that the body of the notification includes the voice mail identifier associated with the stored voice mail. Accordingly, the client device 102A stores the voice mail identifier in the memory so the voice mail identifier can be retrieved if the voice mail is to be recalled in the future. The voice mail server 106 also sends a new voice mail notification to the client device 102B via the SMSC 108.

Although FIG. 1 is described with the voice mail server 106 sending notifications via the SMSC 108, alternatively, the voice mail server 108 can send notifications using any suitable wireless communication channels.

When the user of the client device 102A wishes to recall the voice mail, the client device 102A sends a request to recall the previously stored voice mail to the voice mail server 106 using the SMTP. In accordance with an embodiment of the present invention, the request to recall the voice mail includes a recall field and the voice mail identifier field in the header. The recall field indicates that the request is associated with recalling the previously deposited voice mail and the voice mail identifier field includes an identifier associated with the stored voice mail to be recalled. For example, the value of voice mail identifier may include an IMAP URL or an IMAP ID. Accordingly, the voice mail server 106 recalls an associated voice mail based on the voice mail identifier received in the request.

Thereafter, the voice mail server 106 notifies a status of the recall to the client device 102A via a voice mail recall attempt notification. For example, the voice mail recall attempt notification may indicate whether or not the voice mail was successfully recalled. The voice mail recall attempt notification may include a ‘recall-action’ field in a report type in a content type header to indicate that the body includes the recall-action status (e.g., success or failure).

Additionally, the voice mail server 106 sends a voice mail recalled notification to the client device 102B indicating that the voice mail intended for the client device 102B is recalled by the client device 102A. The voice mail recalled notification includes a ‘recall-status’ field in the report type in the content type header to indicate that body includes a recall-status (e.g., success or failure) associated with the voice mail.

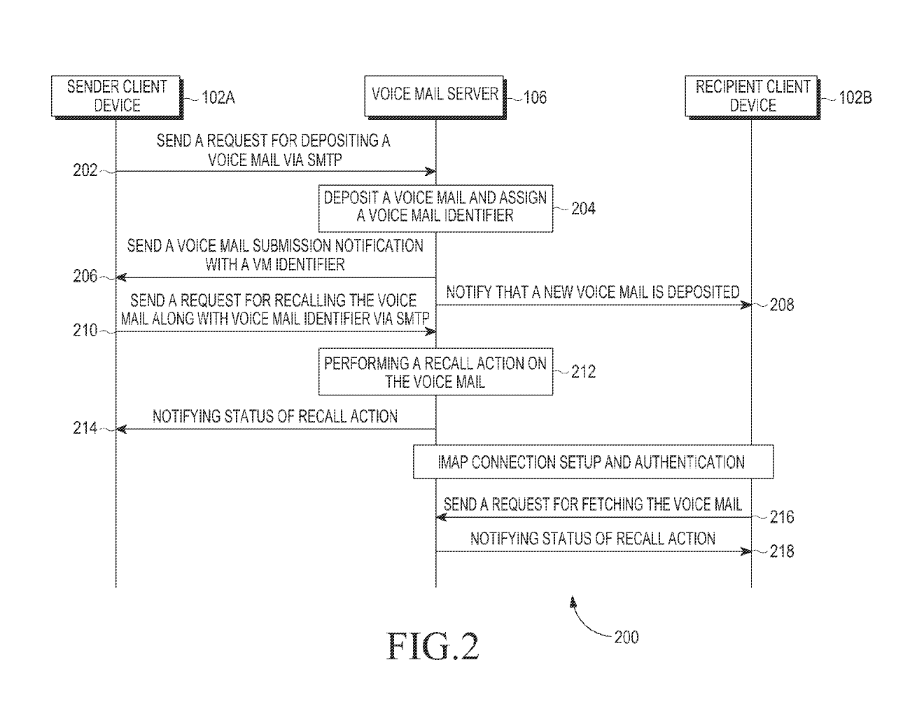

FIG. 2 is a signal flow diagram illustrating a method of recalling a voice mail stored in a voice mail server, according to an embodiment of the present invention.

Referring to FIG. 2, in the signal flow diagram 200, the client device 102A submits a voice mail for the client device 102B over the IP network 104 through a SMTP packet in step 202. As described above, the header of the SMTP packet includes a request for a voice mail identifier (e.g., IMAP URL or IMAP identifier) for the voice mail in the SMTP packet.

In step 204, the voice mail server 106 stores the received voice mail in a memory and assigns a voice mail identifier to the stored voice mail. In step 206, the voice mail server 106 sends a successful voice mail submission notification including the voice mail identifier to the client device 102A, and in step 208, the voice mail server 106 sends a new voice mail notification to the client device 102B, via the SMSC 108, indicating that a new voice mail has been received from the client device 102A.

When the user of the client device 102A then wishes to recall the voice mail stored in the voice mail server 106, in step 210, the client device 102A sends a request to recall the previously stored voice mail including an associated voice mail identifier, to the voice mail server 106, using the SMTP.

In step 212, the voice mail server 106 performs a recall action on the stored voice mail, based on the voice mail identifier received in the request. More specifically, the voice mail server 106 determines whether the previously stored voice mail is present in the memory, i.e., the voice mail server 106 determines whether or not the voice mail has already been retrieved by the client device 102B, prior to the recall request. When the voice mail server 106 has not previously received a request for the stored voice mail from the client device 102B, the voice mail server 102 determines that the voice mail is present in the memory. Thereafter, the voice mail server 102 updates the stored voice mail with a voice mail recall notification. In step 214, using a voice mail recall attempt notification, the voice mail server 106 notifies the client device 102A that the requested voice mail is successfully recalled.

When the client device 102B attempts to download the voice mail from the client device 102A, based on the new voice mail notification received in step 208, an IMAP connection is set up between the voice mail server 106 and client device 102B and the client device 102B is authenticated. In step 216, the client device 102B sends a request to receive the voice mail from the client device 102A and in step 218, the voice mail server 106 notifies the client device 102B that the voice mail has already been recalled by the client device 102A, via a voice mail recalled notification.

Alternatively, the voice mail server 106 may notify the client device 102B that the voice mail has been recalled by the client device 102A, before the client device 102B requests to listen to the voice mail.

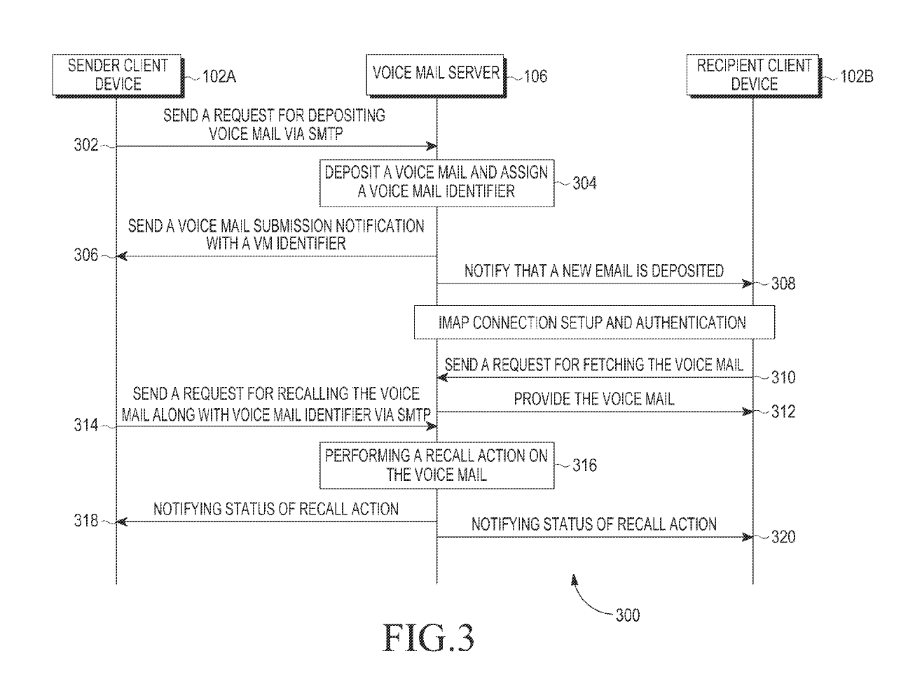

FIG. 3 is a signal flow diagram illustrating a method of recalling a voice mail stored voice mail server, according to an embodiment of the present invention.

Referring to FIG. 3, in the signal flow diagram 300, the client device 102A submits a voice mail for the client device 102B over the IP network 104 through an SMTP packet in step 302. Again, the header of the SMTP packet includes a request for a voice mail identifier (e.g., IMAP URL or IMAP identifier) for the voice mail in the SMTP packet.

In step 304, the voice mail server 106 stores the received voice mail in a memory and assigns a voice mail identifier to the stored voice mail. In step 306, the voice mail server 106 sends a successful voice mail submission notification including the voice mail identifier to the client device 102A.

In step 308, the voice mail server 106 sends a new voice mail notification to the client device 102B, via the SMSC 108, indicating that a new voice mail has been received from the client device 102A.

When the client device 102B wishes to download the voice mail from the client device 102A, based on the new voice mail notification, an IMAP connection is set up between the voice mail server 106 and client device 102B and the client device 102B is authenticated. In step 310, the client device 102B sends a request to retrieve the voice mail from the client device 102A. In step 312, the voice mail server 106 sends the stored voice mail to the client device 102B.

Thereafter, when the client device 102A wishes to recall the voice mail previously stored in the voice mail server 106, in step 314, the client device 102A sends a request to recall the previously stored voice mail with the associated voice mail identifier to the voice mail server 106 using the SMTP.

In step 316, the voice mail server 106 performs a recall action on the stored voice mail, based on the voice mail identifier received in the request. In accordance with an embodiment of the present invention, the voice mail server 106 determines whether the previously stored voice mail is still present in the memory. That is, the voice mail server 106 determines whether or not the voice mail has already been retrieved by the client device 102B, prior to receiving the recall request. In FIG. 3, because the voice mail has already been retrieved by the client device 102B, the voice mail server 102 determines that the voice mail is not present in the memory, and in step 318, notifies the client device 102A that the recall attempt for the stored voice mail has failed, using a voice mail recall attempt notification. In step 320, the voice mail server 106 sends a notification to the client device 102B indicating that an attempt to recall the voice mail has been made by the client device 102A, and that the recall action has failed.

Alternatively, the voice mail server 106 does not notify the client device 102B indicating that an attempt to recall the voice mail has been made by the client device 102A, and that the recall action has failed.

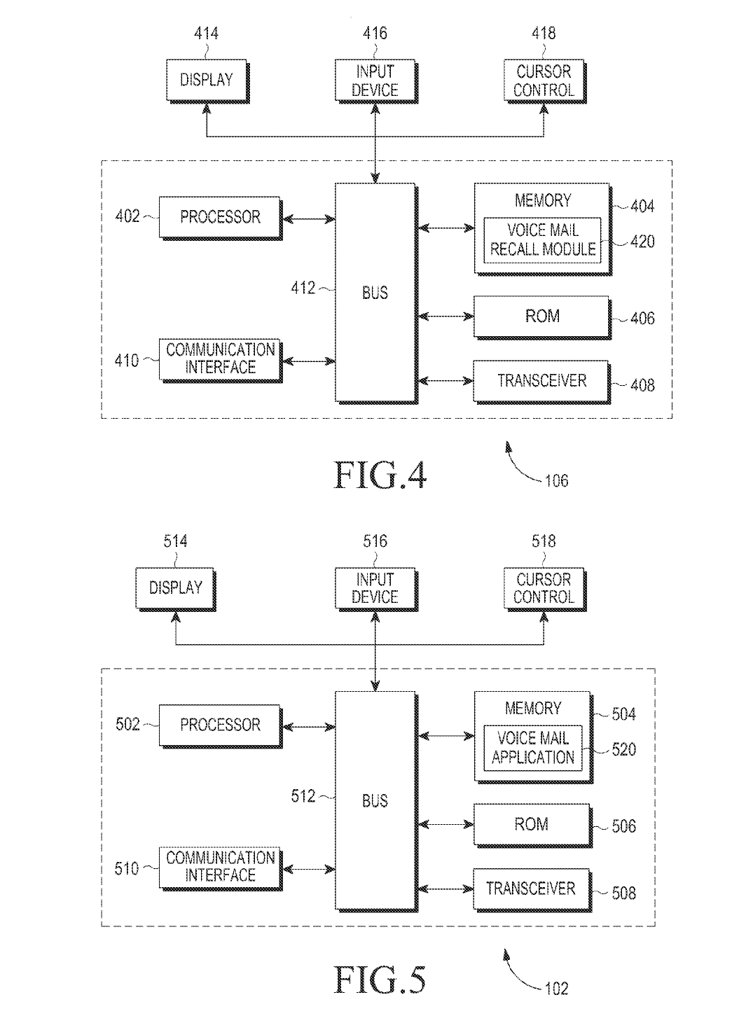

FIG. 4 is a block diagram illustrating a voice mail server according to an embodiment of the present invention.

Referring to FIG. 4, the voice mail server 106 includes a processor 402, a memory 404, a Read Only Memory (ROM) 406, a transceiver 408, a bus 412, a communication interface 410, a display 414, an input device 416, and a cursor control 418.

The processor 402, as used herein, may be any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 402 may also include embedded controllers, such as generic or programmable logic devices or arrays, application specific integrated circuits, single-chip computers, smart cards, etc.

The memory 404 and the ROM 406 may be volatile memory and non-volatile memory. The memory 404 includes a voice recall module 420 in the form of instructions for performing a recall action on a voice mail. A variety of computer-readable storage media may be stored in and accessed from the memory 404 and the ROM 406. For example, the memory 404 and the ROM 406 may include any suitable memory device(s) for storing data and machine-readable instructions, such as read only memory, random access memory, erasable programmable read only memory, electrically erasable programmable read only memory, a hard drive, a removable media drive for handling memory cards, Memory Sticks™, etc.

Various embodiments of the invention may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 402. For example, a computer program may include the voice mail recall module 420 in the form of machine-readable instructions for performing a recall action on one or more voice mails. The computer program may be included on a storage medium and loaded from the storage medium to a hard drive in the non-volatile memory.

In accordance with an embodiment of the invention, the processor 402 is configured to store a voice mail received from the client device 102A and assign a voice mail identifier to the deposited voice mail. Thereafter, the processor 402 is configured to send a successful voice mail submission notification to the client device 102A.

If the client device 102A wishes to recall the voice mail, the processor 402 is configured to receive a request to recall the previously stored voice mail and perform a recall action on the stored voice mail, based on the voice mail identifier received in the request. Further, the processor 402 is configured to notify a status of recall action to the client device 102A via a voice mail recall attempt notification. Additionally, the processor 402 is configured to send a voice mail recalled notification to the client device 102B indicating that the voice mail intended for the client device 102B has been recalled by the client device 102A.

The bus 412 acts as interconnect between various components of the voice mail server 106. The components, such as a transceiver 408, communication interfaces 410, the display 414, the input device 416, and the cursor control 418 are well known to the person skilled in the art and hence the explanation is thereof omitted.

FIG. 5 is a block diagram illustrating a visual voice mail device according to an embodiment of the present invention.

Referring to FIG. 5, the visual voice mail device 102 includes a processor 502, memory 504, a ROM 506, a transceiver 508, a communication interface 510, a bus 512, a display 514, an input device 516, and a cursor control 518.

The processor 502, as used herein, may be any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, etc.

The memory 504 and the ROM 506 may be volatile memory and non-volatile memory. The memory 504 includes a voice recall application 520 in the form of instructions for performing a recall action on a voice mail. A variety of computer-readable storage media may be stored in and accessed from the memory 504 and the ROM 506. For example, the memory 504 and the ROM 506 may include any suitable memory device(s) for storing data and machine-readable instructions, such as read only memory, random access memory, erasable programmable read only memory, electrically erasable programmable read only memory, a hard drive, a removable media drive for handling memory cards, Memory Sticks™, etc.

Various embodiments of the invention may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 502. For example, a computer program may include the voice mail application 520 in the form of machine-readable instructions for performing a recall action on one or more voice mails. The computer program may be included on a storage medium and loaded from the storage medium to a hard drive in the non-volatile memory.

In accordance with an embodiment of the invention, the processor 502 is configured to submit a voice mail to the voice mail server 106 and request a voice mail identifier assigned to the voice mail. If the user wishes to recall the voice mail, the processor 502 is configured to send a request to recall the previously stored voice mail to the voice mail server 106 and notify a status of the recall action to the user.

The bus 512 acts as interconnect between various components of the visual voice mail device 102. The components, such as the transceiver 508, the communication interfaces 510, the display 514, the input device 516, and the cursor control 518 are well known to the person skilled in the art and hence the explanation is thereof omitted.

The various devices, modules, selectors, estimators, etc., as described herein, may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

1-29. (canceled)

30. A method of recalling a voice mail for a recipient client device that is stored in a voice mail server, the method comprising:
receiving, by the voice mail server, a request to recall the voice mail from a sender client device;
performing a recall action on the voice mail, based on the received request; and
notifying at least one of the sender client device and the recipient client device of a status of the recall action.

31. The method of claim 30, further comprising:
receiving a request to store the voice mail for the recipient client device from the sender client device, wherein the request to store the voice mail includes a request for a voice mail identifier;
storing the voice mail received from the sender client device in a memory;
assigning the voice mail identifier to the voice mail; and
sending a voice mail submission notification including the voice mail identifier to the sender client device.

32. The method of claim 31, further comprising notifying the recipient client device that a new voice mail has been stored in the memory.

33. The method of the claim 30, wherein the request to recall the voice mail includes a voice mail identifier associated with the voice mail.

34. The method of claim 33, wherein performing the recall action on the voice mail comprises:
determining whether the voice mail identifier included in the request to recall the voice mail matches a voice mail identifier associated with a voice mail stored in the voice mail server;
determining whether or not the voice mail has already been retrieved by the recipient client device, when the voice mail identifier included in the request to recall the voice mail matches the voice mail identifier associated with the voice mail stored in the voice mail server; and
returning an indication of a failure to recall the requested voice mail to the sender client device, when the voice mail identifier included in the request to recall the voice mail does not match the voice mail identifier associated with the voice mail stored in the voice mail server.

35. The method of claim 34, wherein when the voice mail identifier included in the request to recall the voice mail matches the voice mail identifier associated with the voice mail stored in the voice mail server, further comprising:
notifying the sender client device of a failure to perform the recall action on the voice mail, when the voice mail has already been retrieved by the recipient client device; and
recalling the voice mail stored in the in the voice mail server, when the voice mail has not been retrieved by the recipient client device.

36. The method of claim 35, wherein when the voice mail has not been retrieved by the recipient client device, further comprising:
notifying the sender client device that the voice mail is successfully recalled.

37. The method of claim 32, further comprising:
receiving, from the recipient client device, a request to retrieve the voice mail;
determining whether the voice mail stored by the sender client device is still present in the voice mail server;
providing the voice mail to the recipient client device, when the voice mail is still present in the voice mail server; and
notifying the recipient client device that the voice mail has been recalled by the sender client device, when the voice mail is no longer present in the voice mail server.

38. The method of claim 31, wherein the request for the voice mail identifier is included in a field of a Simple Mail Transfer Protocol (SMTP) packet.

39. The method of claim 31, wherein the voice mail submission notification includes a delivery status field indicating the voice mail identifier of the voice mail.

40. The method of claim 30, wherein the request to recall the voice mail includes a recall field identifying the request is to recall the voice mail and a voice mail identifier field identifying the voice mail identifier associated with the voice mail to be recalled.

40. The method of claim 40, wherein the status of the recall action is notified via a voice mail recall attempt notification.

42. An apparatus recalling a voice mail for a recipient client device that is stored in a voice mail server, the apparatus comprising:
a processor; and
a memory coupled to the processor,
wherein the memory includes a voice mail recall module, which when executed by the processor is configured to receive a request to recall the voice mail from a sender client device, perform a recall action on the voice mail, based on the received request, and notify at least one of the sender client device and the recipient client device of a status of the recall action.

43. The apparatus of claim 42, wherein the voice mail recall module is configured to receive, from the sender client device, the voice mail for the recipient client device and a request for a voice mail identifier associated with the voice mail, store the voice mail received from the sender client device in the memory, assigning the voice mail identifier to the voice mail, and send a voice mail submission notification including the voice mail identifier to the sender client device.

44. The apparatus of claim 43, wherein the voice mail recall module is configured to notify the recipient client device that the voice mail is stored in the memory.

45. The apparatus of claim 44, wherein the voice mail recall module is configured to receive, from the recipient client device, a request to retrieve the voice mail, determine whether or not the voice mail is still present in the memory, provide the voice mail to the recipient client device, when the voice mail is still present in the memory; and
notifying the recipient client device that the voice mail has been recalled by the sender client device, when the voice mail no longer present in the memory.

46. The apparatus of claim 42, wherein the request to recall the voice mail comprises a voice mail identifier associated with the voice mail.

47. A non-transitory computer-readable storage medium having instructions stored therein, that when executed by a processor, cause the processor to perform a method of recalling a voice mail for a recipient client device that is stored in a voice mail server, the method comprising:
receiving a request to recall the voice mail from a sender client device;
performing a recall action on the voice mail, based on the received request; and
notifying at least one of the sender client device and the recipient client device of a status of the recall action.

48. The storage medium of claim 47, wherein the method further comprises:
receiving a request to store the voice mail for the recipient client device from the sender client device, wherein the request to store the voice mail includes a request for a voice mail identifier;
storing the voice mail received from the sender client device in a memory;
assigning the voice mail identifier to the voice mail; and
sending a voice mail submission notification including the voice mail identifier to the sender client device.

49. The storage medium of claim 48, wherein the method further comprises notifying the recipient client device that a new voice mail has been stored in the memory.

50. The storage medium of claim 49, wherein the method further comprises:
receiving, from the recipient client device, a request to retrieve the voice mail;
determining whether the voice mail stored by the sender client device is still present in the voice mail server;
providing the voice mail to the recipient client device, when the voice mail is still present in the voice mail server; and
notifying the recipient client device that the voice mail has been recalled by the sender client device, when the voice mail is no longer present in the voice mail server.

51. The storage medium of claim 47, wherein the request to recall the voice mail includes a voice mail identifier associated with the voice mail.

52. A system comprising:
a sender client device;
a recipient client device;
a voice mail server; and
an Internet Protocol (IP) network communicatively coupling the sender client device, the recipient client device, and the voice mail server,
wherein the sender client device is configured to send a request to recall a voice mail for the recipient client device over the IP network, and
wherein the voice mail server is configured to perform a recall action on the voice mail, based on the request, and to notify at least one of the sender client device and the recipient client device of a status of the recall action.

53. The system of claim 52, wherein the sender client device is configured to send the voice mail for the recipient client device and a request for a voice mail identifier associated with the voice mail.

54. The system of claim 53, wherein the voice mail server is configured to store the voice mail received from the sender client device, assigning the voice mail identifier to the voice mail, and send a voice mail submission notification with the voice mail identifier to the sender client device.

55. The system of claim 54, wherein the voice mail server is configured to notify the recipient client device that the voice mail is sent by the sender client device.

56. The system of claim 55, wherein the receiving device is configured to receive, from the recipient client device, a request to retrieve the voice mail.

57. The system of claim 52, wherein the request to recall the deposited voice mail comprises a voice mail identifier associated with the voice mail.

58. The system of claim 52, wherein the voice mail server is configured to determine whether or not the voice mail is still present in the voice mail server, to provide the voice mail to the recipient client device, when the voice mail is still present in the voice mail server, and to notify the recipient client device that the voice mail has been recalled by the sender client device, when the voice mail is no longer present in the voice mail server.
